(19) United States
(12) Patent Application Publication
(10) Pub. No.: US 2012/0139238 A1
(43) Pub. Date: Jun. 7, 2012

(54) PIPE CONNECTION STRUCTURE

(75) Inventors: Miyoshi Kimura, Isesaki-shi (JP); Tetsuya Yamada, Izunokuni-shi (JP); Tokuo Nakano, Yachiyo-shi (JP)

(73) Assignees: HORIBA STEC, CO., LTD., Kyoto-shi (JP); IHARA SCIENCE CORPORATION, Tokyo (JP)

(21) Appl. No.: 13/308,398

(22) Filed: Nov. 30, 2011

(30) Foreign Application Priority Data
Dec. 1, 2010 (JP) 2010-268768

(51) Int. Cl. F16L 25/00; F16L 23/00

(52) U.S. Cl. 285/421

(57) ABSTRACT

To prevent attachment in an inclined state, a coupling ring with an inner concave groove is fitted to an outer circumferences of abutting flange portions, and is fastened to reduce an inner diameter thereof so that an inclined surface formed on each side surface of the concave groove presses an inclined surface formed on an opposite surface of each of the flange portions. The pair of flange portions are coupled by force generated at the time of pressing. An attachment correcting surface is provided on each of the flange portions or each of the pipes so that, only where the coupling ring is attached and fastened in an orientation inclined at an angle equal to or larger than a prescribed angle, the attachment correcting surface is abutted to a part of the coupling ring prior to completion of the fastening so as to prohibit the part from being brought closer.

### FIELD OF THE INVENTION

The present invention relates to a pipe connection structure connecting a pair of pipes and, more particularly, to a pipe connection structure serially connecting a pair of pipes provided with flange portions at the ends thereof.

### BACKGROUND ART

As a pipe connection structure of this kind, there is known a structure that is provided with flange portions at the ends so that the flange portions are coupled using a coupling ring (Patent Literature 1). In an inner circumferential surface of the coupling ring, there is formed a concave groove extending in a circumferential direction.

When connecting the pipes, after the concave groove is fitted to outer circumferences of the abutting flange portions, an inner diameter of the coupling ring is narrowed using a fastener. Thus, an inclined surface formed on each of side surfaces of the concave groove presses an inclined surface formed on an opposite surface at an opposed side to the abutting surface of each of the flange portions. At this time, there is generated a component of force for pressing the flange portions in an axial direction so that the flange portions are coupled by pressure contact by the component of force.

### CITATION LIST

### Patent Literature

Patent Literature 1: JP2008-286325A

### SUMMARY OF INVENTION

### Technical Problem

However, if the coupling ring is oblique to the flange portions when attaching the coupling ring, even though the fastener is tightened, there arises a problem that the pipes in the pair are not fully in close contact with each other and there occurs a misalignment between axes of the pair of pipes. As a result, the pipes are not properly connected and there may arise a risk that leaks of a fluid flowing inside the pipes are caused.

### SUMMARY OF THE INVENTION

Therefore, the present invention has been made to solve the problem mentioned above, and an object thereof is to provide a pipe connection structure capable of surely connecting a pair of pipes while preventing a coupling ring from being obliquely attached to the flange portions in an inclined state with respect to the flange portions.

### Solution to Problem

Accordingly, the pipe connection structure pertaining to one aspect of the present invention is adapted to have a construction that, in a state that flange portions respectively provided at ends of a pair of pipes are abutting, a coupling ring provided with a concave groove extending in a circumferential direction in an inner circumferential surface thereof is fitted to an outer circumference of the abutting flange portions, wherein the coupling ring is fastened so as to reduce an inner diameter thereof so that an inclined surface formed on each side surface of the concave groove presses an inclined surface formed on a opposite surface opposite to each of the abutting surfaces of the flange portions, whereby the pair of flange portions are coupled by pressure contact by axial components of force generated at the time of pressing. In this construction, an attachment correcting surface is provided on each of the flange portions or each of the pipes so that, only in the case where the coupling ring is attached to the flange portions and fastened in an orientation remaining inclined at an angle equal to or larger than a prescribed angle rather than that in a normal attachment orientation, the attachment correcting surface is abutted to a part of the coupling ring prior to completion of the fastening so as to prohibit the part from being brought closer to the pipes side any more substantially, whereby the orientation of the coupling ring is approximated to the normal attachment orientation along with the subsequent fastening.

With this configuration, only in the case where the coupling ring is attached to the flange portions and fastened while the attachment correcting surfaces are inclined at an angle equal to or larger than the prescribed angle rather than the normal attachment orientation, the attachment correcting surface is abutted to the part of the coupling ring before completion of the fastening so as to prevent the part from drawing closer to the pipes side any more substantially and the orientation of the coupling ring is approximated to the normal attachment orientation by the subsequent fastening thereof. Therefore, even in the case where the coupling ring is oblique to the pipes at the time of attaching the coupling ring, the part of the coupling ring is kept away from the pipes side while the other part of the coupling ring is caused to draw closer to the pipes side so that the inclination of the coupling ring with respect to the flange portions can be reduced so as to be able to improve the orientation of the coupling ring. As a result, the coupling ring can be prevented from being attached in a state of being obliquely inclined with respect to the flange portions so that the flange portions can be securely coupled and the pipes respectively provided with the flange portions can be securely connected.

In order to improve the orientation of the coupling ring more surely, it is desirable that each of the attachment correcting surfaces is provided on a protruded portion protruding from an intermediate portion of each of the inclined surfaces of the flange portions.

In the case where each of the protruded portions circumscribes and each of the attachment correcting surfaces has an annular shape, the orientation of the coupling ring can be improved even if the coupling ring is attached to the flange portions in any direction.

Also, a flange-equipped pipe for use in the pipe connection structure is one aspect of the present invention. More specifically, the flange-equipped pipe includes: the pipe; the flange portion provided at an end of the pipe; and the attachment correcting surface formed on the pipe or the flange portion.

### Advantageous Effects of the Invention

According to the pipe connection structure using the pipes and the coupling ring constructed as described above, the coupling ring can be prevented from being attached to the flange portions in an inclined state with respect to the flange portions so that the pipes can be securely connected.

### BRIEF DESCRIPTION OF THE DRAWINGS

FIG. 1 is an exploded view showing a pipe connection structure pertaining to one embodiment of the present invention;

FIG. 2 is a longitudinal section view showing a normal connection completion state of the pipe connection structure in the same embodiment;

FIG. 3 is a partial lateral section view showing an opened state of a coupling ring in the same embodiment;

FIG. 4 is a diagram showing a coupled state of the coupling ring in the same embodiment;

FIG. 5 is a longitudinal section view showing a connecting process in an inclined state of the pipe connection structure in the same embodiment;

FIG. 6 is a longitudinal section view showing a slightly inclined connection completion state of the pipe connection structure in the same embodiment;

FIG. 7 is a longitudinal section view showing a connection completion state of a pipe connection structure in another embodiment; and

FIG. 8 is a longitudinal section view showing a connection completion state of a pipe connection structure in further another embodiment.

### REFERENCE CHARACTERS LIST

100 . . . Pipe connection structure
10 . . . Pipe
20 . . . Flange portion
22 . . . Inclined surface of flange portion
40 . . . Coupling ring
43 . . . Concave groove
43a . . . Inclined surface of coupling ring
44 . . . Surface to be corrected
44a . . . Part of surface to be corrected
51 . . . Attachment correcting surface
A1 . . . Axis of flange portion
A2 . . . Axis of coupling ring

### DESCRIPTION OF THE EMBODIMENTS

The following describes one embodiment of the present invention referring to the accompanying drawings. A pipe connection structure 100 pertaining to the present embodiment is adapted to connecting a pair of pipes 10 in series and is used in, for example, a fluid supply line that includes the pipes 10 and fluid equipment (not shown) to be connected by the pipes 10. The pipe connection structure 100 includes a pair of flange portions 20 respectively provided at tip ends of the paired pipes 10, a gasket 30 interposed between the paired flange portions 20, and a coupling ring 40 for coupling the flange portions 20.

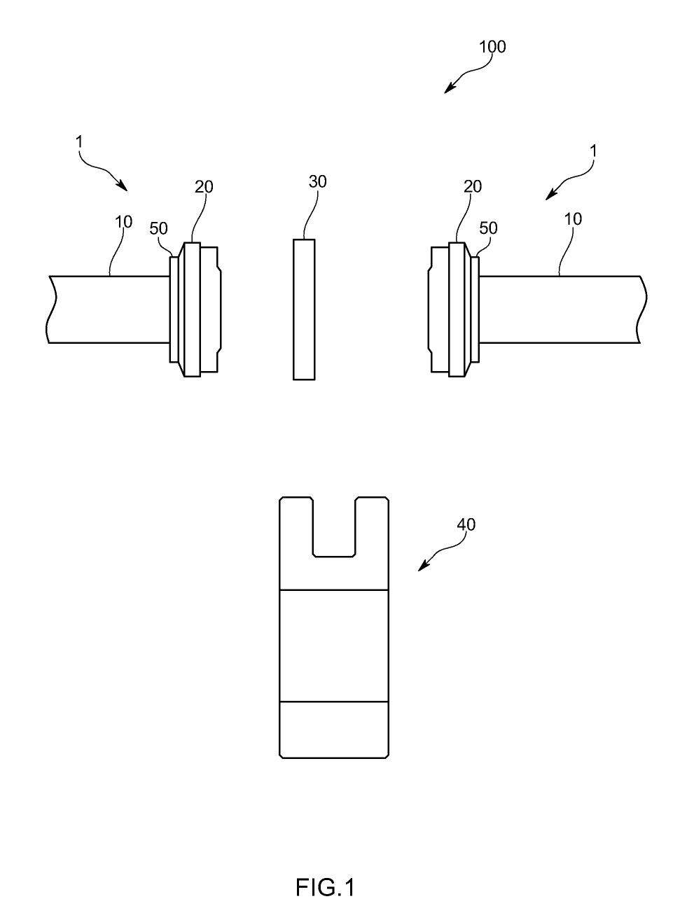

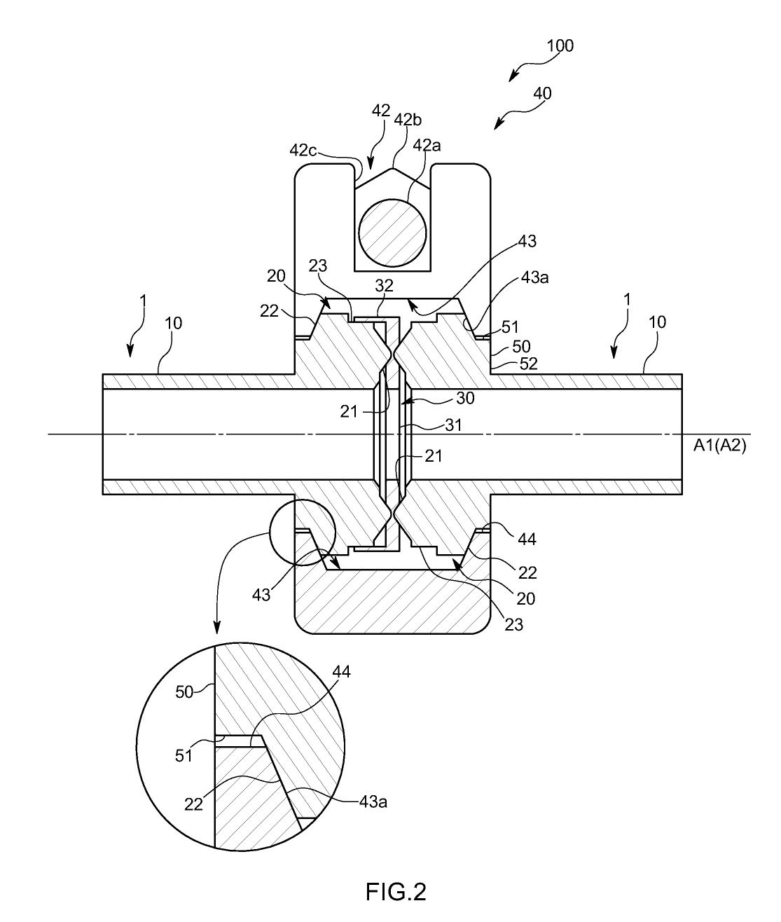

As shown in FIGS. 1 and 2, each of the flange portions 20 has a generally annular plate shape and is provided integrally with the pipe 10 in a manner such that an axis A1 of the flange portion 20 is substantially aligned with an axis of the pipe 10. The flange portion 20 together with the pipe 10 constitutes a part of a flange-equipped pipe 1. As shown in FIG. 2, an annular-shaped protrusion 21 is provided on a tip end surface (referred to as “abutting surface” or “end-to-end facing surface” hereinafter) of the flange portion 20 and an inclined surface 22 is formed on an opposite surface of the flange portion 20 with its diameter being larger toward the tip end thereof. A stepped portion 23 having a slightly smaller diameter is formed at a tip end in a side circumferential surface of the flange portion 20.

As shown in FIG. 2, the gasket 30 is sandwiched between the paired flange portions 20 and the protrusion 21 of the flange portion 20 is engaged in the gasket 30 so as to ensure hermeticity. Specifically, the gasket 30 includes a gasket body 31 having a uniform-thick annular plate shape that is sandwiched between the paired flange portions 20 and a fitting portion 32 having a generally cylindrical shape to which the gasket body 31 is attached so as to close one end of the flange portion. An inner diameter of the fitting portion 32 is so defined as to be substantially coincident with an outer diameter of the stepped portion 23 of the flange portion 20 and the fitting portion 32 is fitted to the stepped portion 23 so that the axis of the gasket body 31 is substantially aligned with the axis A1 of the flange portion 20. An outer diameter of the fitting portion 32 is so defined as to be smaller than an outer diameter of a proximal end of a side circumferential surface which corresponds to a part having the largest diameter of the flange portion 20. An inner diameter of the gasket body 31 is substantially equal to an inner diameter of the pipe 10.

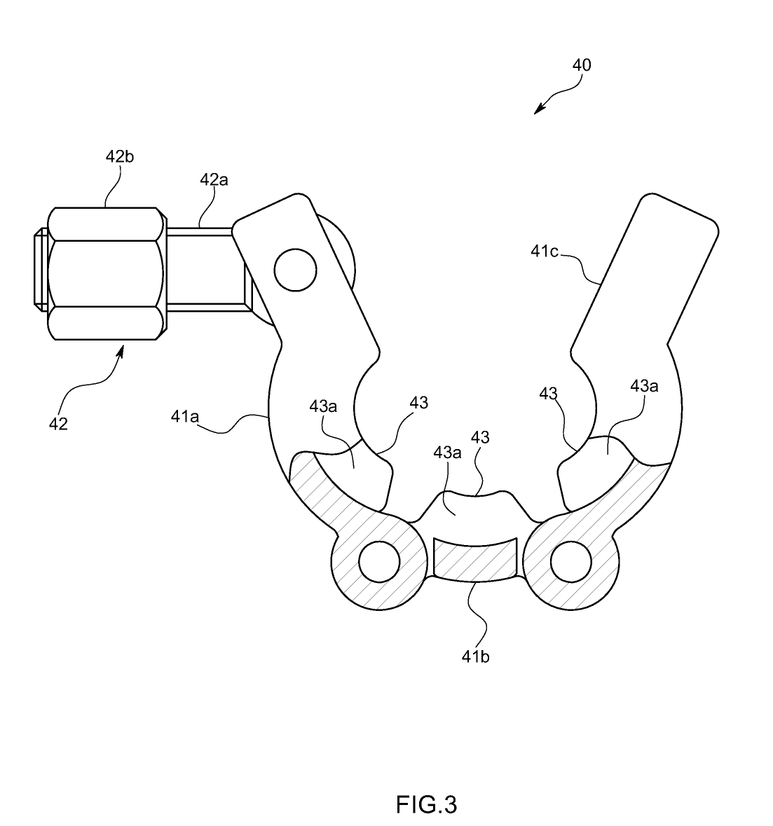

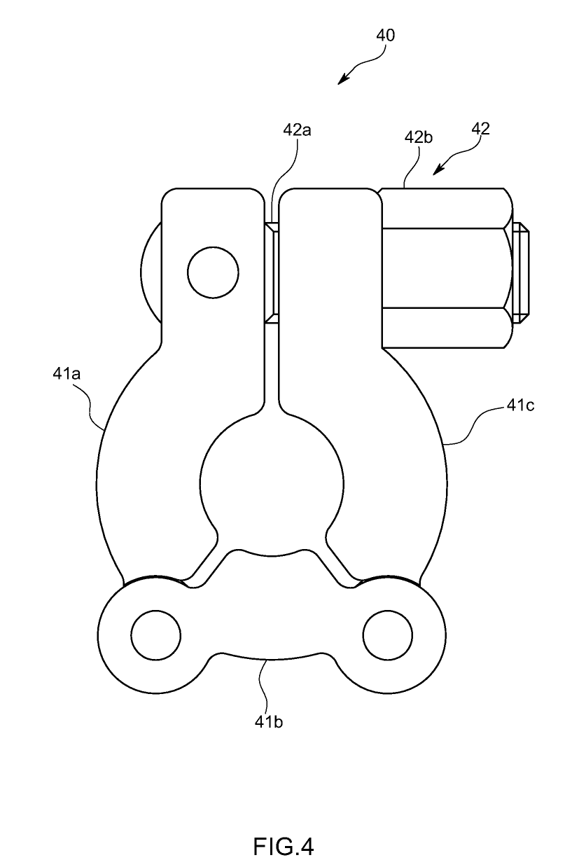

The coupling ring 40, as an opened state thereof shown in FIG. 3 and an annular state thereof shown in FIG. 4, includes a series of unit members 41a to 41c of which adjoining ones are rotatably coupled to each other and a fastener 42 for coupling the unit members 41a and 41c at the both ends thereof to form an annular state of a series of the unit members 41a and 41c. There is formed a concave groove 43 extending in a circumferential direction in an inner circumferential surface of each of the unit members 41a to 41c (herein, three unit members). As shown in FIG. 2, each of the concave grooves 43 has a width to be fitted to the outer circumferences of the end-to-end facing, i.e., abutting, flange portions 20 and there is formed an inclined surface 43a inclined at an angle corresponding to the inclined surface 22 of each of the flange portions 20 on each of the side surfaces of the concave groove 43. There are formed annular planes (each also referred to as “correction surface 44” hereinafter) in parallel to the axis A2 of the coupling ring 40 with the axis A2 of the coupling ring 40 as a center thereof at both edges of the concave groove 43.

As shown in FIGS. 3 and 4, etc., the fastener 42 includes a bolt portion 42a and a nut portion 42b. The bolt portion 42a has its proximal end rotatably coupled to a tip end of the unit member 41a located at one end of the three unit members and, as shown in FIG. 2, it is adapted to be fitted into a groove-shaped notch 42c formed in a tip end of the unit member 41c located at the other end of the three unit members. By screwing the nut portion 42b with the bolt portion 42a fitted in the notch 42c and protruded therefrom, the unit members 41a and 41c at the both ends are coupled so that the inner diameter of the coupling ring 40 can be increased and decreased.

Moreover, the pipe connection structure 100 further includes a pair of protruded portions 50. As shown in FIGS. 1 and 2, etc., each of the protruded portions 50 has a generally annular shape and, in this configuration, it is protruded from an intermediate portion of the inclined surface 22 (herein, proximal portion of the inclined surface 22) of each of the flange portions 20 and it is provided so as to circumscribe the proximal portion of the flange portion 20. A radially outward surface (referred to as “attachment correcting surface 51” hereinafter) of the protruded portion 50 is an annular surface with the axis A1 of the flange portion 20 as a center thereof and is in parallel to the axis A1 of the flange portion 20 and is continuous to the inclined surface 22 in this configuration. The axial length of the attachment correcting surface 51 is defined in a manner such that the axial length of the coupling ring 40 is substantially equal to the axial lengths of the paired abutting flange portions 20 and the protruded portions 50. An axially outward surface 52 of each of the protruded portions 50 is an annular plate shaped surface perpendicular to the axis A1 of the flange portion 20.

Herein, it is assumed that the attachment correcting surface 51 is parallel to the axis A1 of the flange portion 20, that is, a normal vector of the attachment correcting surface 51 includes a radially outward component but does not substantially include a component parallel to the axis. However, the attachment correcting surface 51 is not limited to this and it may be inclined toward a side of the proximal end or the distal end. In the case where the attachment correcting surface 51 is inclined toward the proximal end side (i.e., in the case where the normal vector includes a component parallel to the axial direction and toward the proximal end side and a radially outward component), the inclination of the attachment correcting surface 51 with respect to the axis A1 of the flange 20 is smaller than the inclination of the inclined surface 22 of the flange 20. Meanwhile, in the case where the attachment correcting surface 51 is inclined toward the distal end side (i.e., in the case where the normal vector includes a component parallel to the axial direction and toward the distal end side and a radially outward component), the inclination may be formed to be radially outward.

The following describes an example of a procedure of connecting the paired pipes 10 using the pipe connection structure 100 as described above while explaining the attachment correcting surface 51 and the correction surface 44 (i.e., the surface to be corrected). Initially, referring to FIG. 2, described is a case where the coupling ring 40 is little oblique to the flange portions 20 and remains in the normal attachment orientation or attitude when attaching the coupling ring 40.

First, the fitting portion 32 of the gasket 30 is fitted to the stepped portion 23 of one of the paired flange portions 20 so that the axis of the gasket 30 is substantially aligned with the axis A1 of the flange portions 20 while the protrusion 21 of the one of the paired flange portions 20 is abutted to one surface of the gasket body 31. Further, the protrusion 21 of the other flange portion 20 is abutted to the opposite surface of the gasket body 31.

Subsequently, the coupling ring 40 in the opened state of the unit members 41a and 41c at both ends being not joined is wound around the outer circumferences of the abutting flange portions 20 so that the concave groove 43 of the coupling ring 40 is fitted to the outer circumferences. Then, the unit members 41a and 41c at both ends are joined and fastened by the fastener 42 so as to shrink the inner diameter of the coupling ring 40.

In the process of tightening the coupling ring 40, the correction surfaces 44 of the coupling ring 40 draw closer to the attachment correcting surfaces 51 of the flange portions 20. Since the coupling ring 40 keeps the normal attachment orientation or an orientation equivalent thereto with respect to the flange portions 20, the correction surfaces 44 draw closer to the pipes 10 side while the correction surfaces 44 remain in a state of being spaced from the attachment correcting surfaces 51 without abutting thereto. Herein, the state of the coupling ring 40 being in the normal attachment orientation means that the axis A1 of the flange portions 20 is substantially aligned with the axis A2 of the coupling ring 40, and the orientation equivalent thereto means a state that the coupling ring 40 is slightly inclined and, more specifically, means a state that an inclination angle between the axes A1 and A2 is smaller than a prescribed angle (herein, equal to or smaller than 3 degrees and, preferably, 1 degree).

In parallel with the drawing of the attachment correcting surfaces 51 closer to the correction surfaces 44, the inclined surfaces 43a of the concave groove 43 pressingly push the inclined surfaces 22 of the flange portions 20. At this time, there are caused components of force in a direction of pressing the paired flange portions 20 to be axially brought into close contact with each other. Thus, the paired flange portions 20 are pressed to each other by the components of force so that the protrusions 21 dig into the gasket 30, and therefore the pipes 10 are hermetically connected with each other.

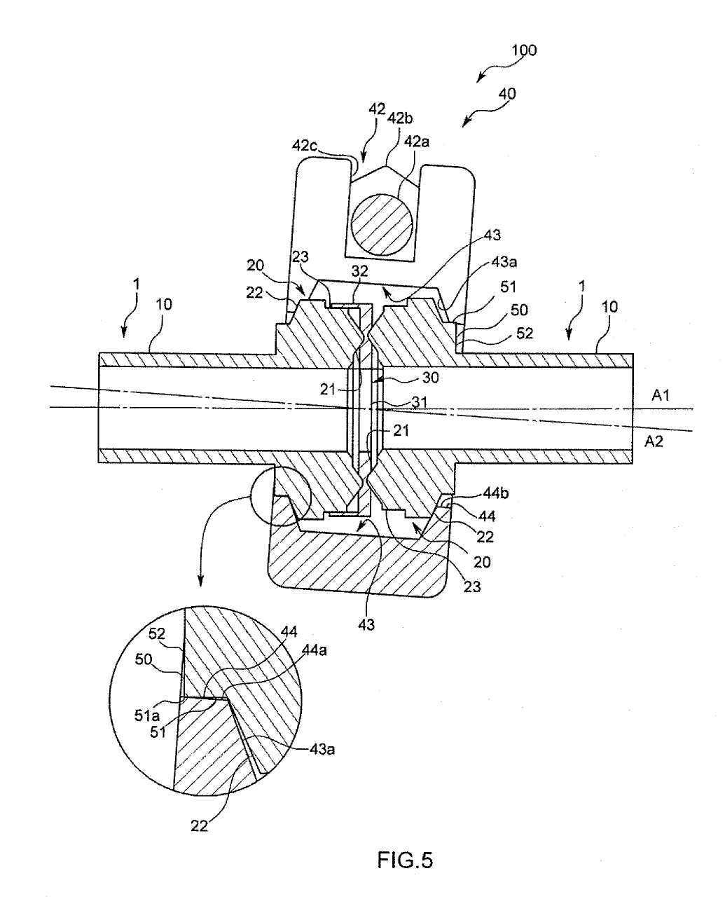

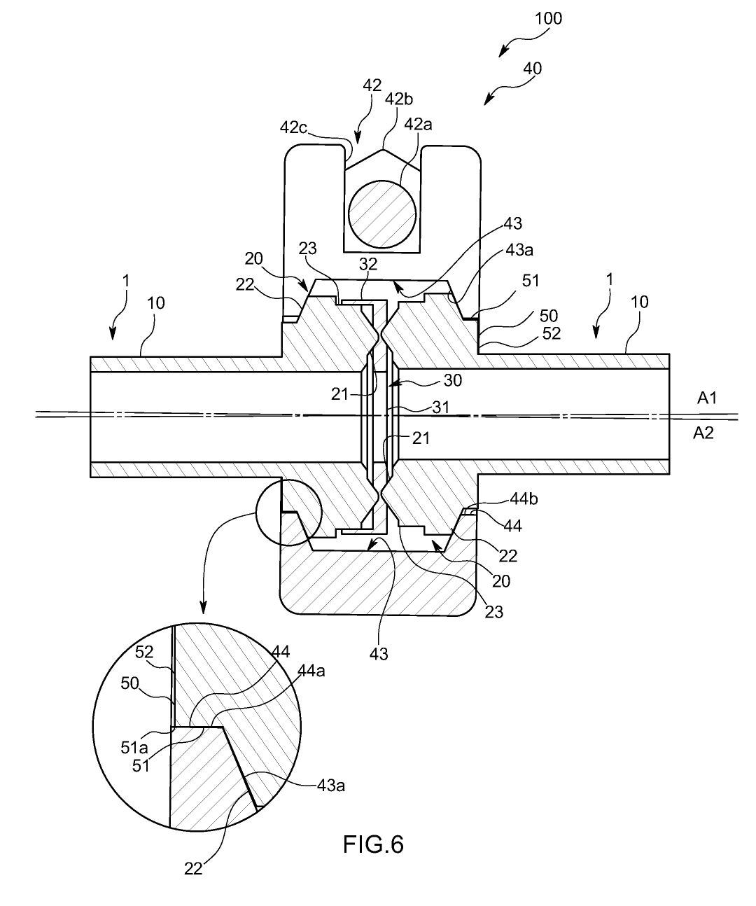

Next, referring to FIGS. 5 and 6, described is a case where the coupling ring 40 is oblique to the flange portions 20 and does not remain in the normal attachment orientation when attaching the coupling ring 40.

First, in a similar manner to the procedure mentioned above, the paired flange portions 20 and the gasket 30 are assembled. Next, the coupling ring 40 is attached to the flange portions 20 to be fastened. However, in this fastening process of the coupling ring 40, as shown in FIG. 5, the coupling ring 40 is inclined at an angle equal to or larger than the prescribed angle rather than the normal attachment orientation. Herein, the state of the coupling ring 40 being in the inclined orientation or inclined attitude means that the inclination angle between the axis A1 of the flange portions 20 and the axis A2 of the coupling ring 40 is equal to or larger than the prescribed angle.

As the coupling ring 40 is fastened, the inner diameter of the coupling ring 40 is narrowed so that the correction surfaces 44 of the coupling ring 40 draw closer to the attachment correcting surfaces 51 of the flange portions 20. At this time, since the coupling ring 40 is inclined, a part 44a of the correction surfaces 44 of the coupling ring 40 (herein, one end portion of the correction surfaces 44) is abutted to the attachment correcting surface 51 (i.e., an outer periphery 51a of the attachment correcting surface 51). Thus, the part 44a of the correction surfaces 44 cannot draw closer to the pipes 10 side (the radial direction) any more. In this state, the distance between the other part 44b of the correction surfaces 44 (herein, the other end portion of the correction surfaces 44) and the axis A1 of the flange portions 20 becomes larger than the distance between the part 44a of the correction surfaces 44 and the axis A1 of the flange portions 20.

Then, as the coupling ring 40 is further fastened, the part 44a of the correction surfaces 44 does not move or moves in parallel to the axial direction while keeping the distance from the pipes 10 side (i.e., the distance with respect to the axis A1 of the flange portions 20). Meanwhile, the other part 44b of the coupling ring 40 draws further closer to the pipes 10 side. Thus, the distance between the other part 44b of the correction surface 44 and the axis A1 of the flange portions 20 is reduced so as to be approximated to the distance between the part 44a of the correction surfaces 44 and the axis A1 of the flange portions 20. As a result, the inclination of the coupling ring 40 is reduced so that the orientation, i.e., attitude, of the coupling ring 40 is approximated to the normal attachment orientation.

In a similar manner to the procedure mentioned above, in parallel with the drawing of the attachment correcting surfaces 51 closer to the correction surfaces 44, the inclined surfaces 43a of the concave groove 43 pressingly push the inclined surfaces 22 of the flange portions 20, and the paired flange portions 20 are pressed to each other by the components of force caused at this time so that the pipes 10 are hermetically connected with each other. Comparing the state before completion of the fastening shown in FIG. 5 and the state after completion of the fastening shown in FIG. 6, the orientation of the coupling ring 40 is improved at the time of completion of the fastening and it is found that the inclination is reduced.

With this configuration, only in the case where the coupling ring 40 is attached to the flange portions 20 and fastened while the attachment correcting surfaces 51 are inclined at an angle equal to or larger than the prescribed angle rather than the normal attachment orientation, the attachment correcting surface 51 is abutted to the part 44a of the coupling ring 40 before completion of the fastening so as to prevent the part 44a from drawing closer to the pipes 10 side any more and the orientation of the coupling ring 40 is approximated to the normal attachment orientation by the subsequent fastening thereof. Therefore, even in the case where the coupling ring 40 is oblique to the pipes 10 at the time of attaching the coupling ring 40, the part 44a of the coupling ring 40 is kept away from the pipes 10 side while the other part 44b of the coupling ring 40 is rendered to draw closer to the pipes 10 side so that the inclination of the coupling ring 40 with respect to the flange portions 20 can be reduced so as to be able to improve the orientation of the coupling ring 40. As a result, the coupling ring 40 can be prevented from being attached in a state of being obliquely inclined with respect to the flange portions 20 so that the flange portions 20 can be securely coupled and the pipes 10 respectively provided with the flange portions 20 can be securely connected.

Moreover, since the axial length of each of the attachment correcting surfaces 51 is defined so that the axial length of the coupling ring 40 is substantially coincident with the axial lengths of the abutting paired flange portions 20 and the protruded portions 50, the protruded portions 50 can be substantially prevented from being protruded from the coupling ring 40 so that the length of the flange-equipped pipe 1 can be reduced as small as possible.

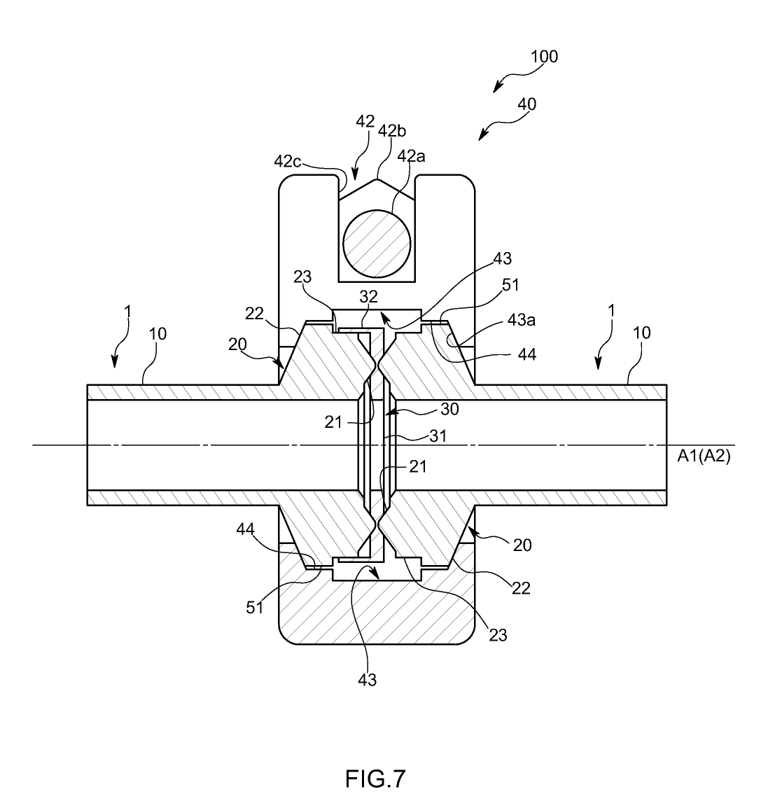

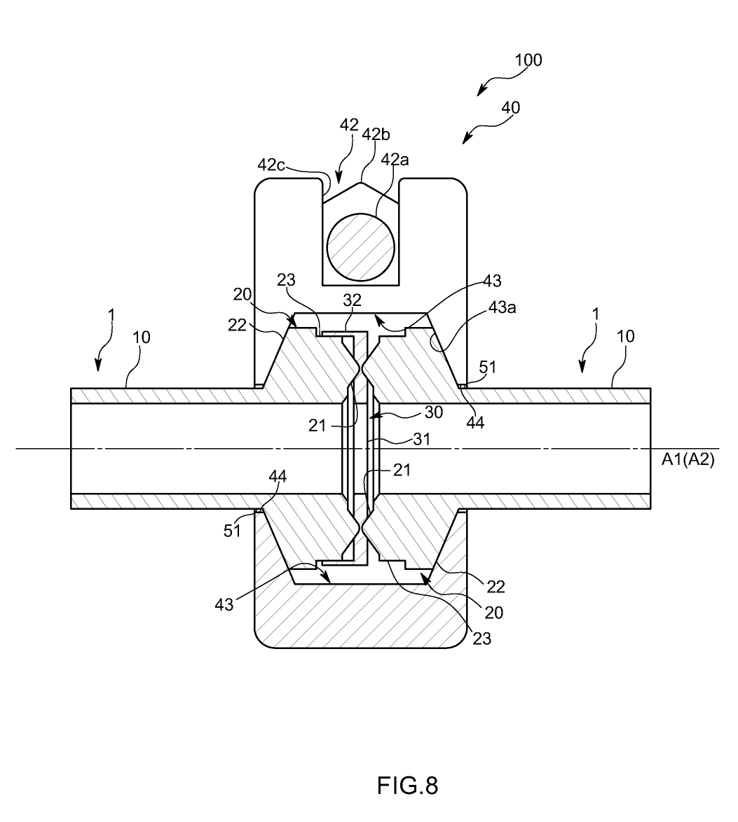

In addition, the present invention should not be limited to the above embodiment. For example, although the attachment correcting surface formed on the protruded portion protruding from the inclined surface of each of the flange portions, it may be formed on the side circumferential surface of the flange portion or an outer circumferential surface of each of the pipes. As a specific example, as shown in FIG. 7, an annular protruded portion is provided on each of the inclined surfaces of the concave groove of the coupling ring and the correction surface is formed on a radially inward surface of the protruded portion and the attachment correcting surface is formed on the side circumferential surface of each of the flange portions. Moreover, as an example of forming the attachment correcting surface on the outer circumferential surface of the pipe, as shown in FIG. 8, the edge of the coupling ring is further inwardly protruded in the radial direction so as to form the correction surface of the protruded portion. In addition, the protruded portion may be provided by a separate body instead of being provided integrally with the flange portion or the pipe. In addition, the present invention may be variously changed within the scope of the present invention unless departing from the spirit thereof.

### INDUSTRIAL APPLICABILITY

With the pipe connection structure of the present invention, the coupling ring can be prevented from being attached in a state of being obliquely inclined with respect to the flange portions so that the pipes can be securely connected.

1. A pipe connection structure adapted to have a construction that, in a state that flange portions respectively provided at ends of a pair of pipes are abutting, a coupling ring provided with a concave groove extending in a circumferential direction in an inner circumferential surface thereof is fitted to an outer circumferences of the abutting flange portions, wherein the coupling ring is fastened so as to reduce an inner diameter thereof so that an inclined surface formed on each side surface of the concave groove presses an inclined surface formed on a opposite surface opposite to each of the abutting surfaces of the flange portions, whereby the pair of flange portions are coupled by pressure contact by axial components of force generated at the time of pressing,
wherein an attachment correcting surface is provided on each of the flange portions or each of the pipes so that, only in the case where the coupling ring is attached to the flange portions and fastened in an orientation remaining inclined at an angle equal to or larger than a prescribed angle rather than that in a normal attachment orientation, the attachment correcting surface is abutted to a part of the coupling ring prior to completion of the fastening so as to prohibit the part from being brought closer to the pipes side any more substantially, whereby the orientation of the coupling ring is approximated to the normal attachment orientation along with the subsequent fastening.

2. The pipe connection structure according to claim 1, wherein the attachment correcting surface is provided on a protruded portion protruding from an intermediate portion of the inclined surface of each of the flange portions.

3. The pipe connection structure according to claim 2, wherein the protruded portion circumscribes and the attachment correcting surface is annular shaped.

4. A flange-equipped pipe for use in the pipe connection structure according to claim 1, comprising: the pipe; the flange portion provided at an end of the pipe; and the attachment correcting surface provided on the pipe or the flange portion.
